(19) United States
(12) Patent Application Publication
(10) Pub. No.: US 2008/0016921 A1
(43) Pub. Date: Jan. 24, 2008

(54) STRAP LOCK WITH AN INDICATOR

(76) Inventor: CHUN TE YU, Fusing Township (TW)

Correspondence Address: HDSL, 4331 STEVENS BATTLE LANE, FAIRFAX, VA, 22033, US

(21) Appl. No.: 11/829,959

(22) Filed: Jul. 30, 2007

Related U.S. Application Data
(63) Continuation-in-part of application No. 10/792,875, filed on Mar. 5, 2004.
(63) Continuation-in-part of application No. 10/998,647, filed on Nov. 30, 2004.
(63) Continuation-in-part of application No. 11/396,696, filed on Apr. 4, 2006.
(63) Continuation-in-part of application No. 11/474,936, filed on Jun. 27, 2006.

(30) Foreign Application Priority Data
Jul. 5, 2007 (TW) 096124537

(51) Int. Cl. E05B 73/00

(52) U.S. Cl. 70/18; 70/21

(57) ABSTRACT

A strap lock includes a strap, a first snapping member, a second snapping member, a key locking mechanism and an indicator. The first snapping member is connected with one end of the strap. The second snapping member is detachably connected to the first snapping member and includes a crossbar for being looped by the other end of the strap such that a distal end of the other end of the strap is limited to be pulled in a direction away from the second snapping member so as to adjust a loop size defined by the strap. The key locking mechanism is disposed on the first snapping member and includes a core shaft defining a key hole for being inserted by a specific key such that the core shaft can be driven by the key to release the second snapping member from the first snapping member. The indicator is movably disposed on the first snapping member and moves from a first displaying position to a second displaying position when the key is inserted into the key hole of the core shaft.

### CROSS REFERENCE TO RELATED APPLICATION

This is a continuation-in-part of application Ser. No. 10/792,875, filed on Mar. 5, 2004; a continuation-in-part of application Ser. No. 10/998,647, filed on Nov. 30, 2004; a continuation-in-part of application Ser. No. 11/396,696, filed on Apr. 4, 2006; and also a continuation-in-part of application Ser. No. 11/474,936, filed on Jun. 27, 2006.

### BACKGROUND OF INVENTION

1. Field of Invention

The present invention relates to a strap lock and in particular to a strap lock with an indicator.

2. Related Prior Art

U.S. Patent Application No. 2006/0266084 discloses a travel padlock which includes an indicator and a key lock having a key hole. When the key hole is inserted by a key or an object, the indicator moves to a displaying position, notifying a user that the padlock has been operated and his luggage is better to be checked immediately. Nevertheless, the padlock is a kind of lock much different from a strap lock.

In addition, U.S. Patent Application No. 2007/0084256 discloses a strap lock with an indicator. The strap lock can be locked or unlocked by either one of a key locking mechanism and a combination locking mechanism. The key locking mechanism includes a core shaft having a key hole which can be inserted by a key. However, the indicator moves to a displaying position only when the key is inserted into the key hole and drives the core shaft to rotate. Furthermore, the strap lock defines no opening for being inserted by an insert to enable the indicator to move back to its original position.

### SUMMARY OF INVENTION

The primary object of this invention is therefore to provide a strap lock with an indicator which moves to a displaying position upon insertion of a key or an object longitudinally into a key hole thereof.

According to the present invention, a strap lock includes a strap, a first snapping member, a second snapping member, a key locking mechanism and an indicator. The first snapping member is connected with one end of the strap. The second snapping member is detachably connected to the first snapping member and includes a crossbar for being looped by the other end of the strap such that a distal end of the other end of the strap is limited to be pulled in a direction away from the second snapping member so as to adjust a loop size defined by the strap. The key locking mechanism is disposed on the first snapping member and includes a core shaft defining a key hole for being inserted by a specific key such that the core shaft can be driven by the key to release the second snapping member from the first snapping member. The indicator is movably disposed on the first snapping member and moves from a first displaying position to a second displaying position when the key is inserted into the key hole of the core shaft.

Preferably, the first snapping member defines an opening capable of receiving an insert to enable the indicator to move from the second displaying position to the first displaying position.

Preferably, the strap lock further comprises a combination locking mechanism disposed on the first snapping member. The combination locking mechanism can release the second snapping member from the first snapping member by entering a code. The indicator is allowed moving from the second displaying position to the first displaying position only when the combination locking mechanism is entered the code.

Further benefits and advantages of the present invention will become clear as the description proceeds.

### BRIEF DESCRIPTION OF DRAWINGS

The invention will now be elucidated with reference to the following description and accompanying drawings where:

FIG. 1 is a top exploded view of a strap lock according to a first embodiment of the present invention;

FIG. 2 is a bottom exploded view of the strap lock of FIG. 1;

FIGS. 3 and 4 are partial top and cross-sectional views of the strap lock respectively, showing that an indicator of the strap is in a first displaying position;

FIGS. 5 and 6 are partial top and cross-sectional views of the strap lock respectively, showing that the indicator is in a second displaying position;

FIG. 7 is a cross-sectional view of the strap lock in a locking state;

FIG. 8 shows that the strap lock is unlocked via a key locking mechanism;

FIG. 9 shows that the strap lock is unlocked via a combination locking mechanism;

FIG. 10 is an exploded view of a strap lock according to a second embodiment of the present invention; and

FIG. 11 shows that the strap lock of FIG. 10 includes an opening exposed only when the strap is unlocked via a combination locking mechanism.

### DETAILED DESCRIPTION OF EMBODIMENTS

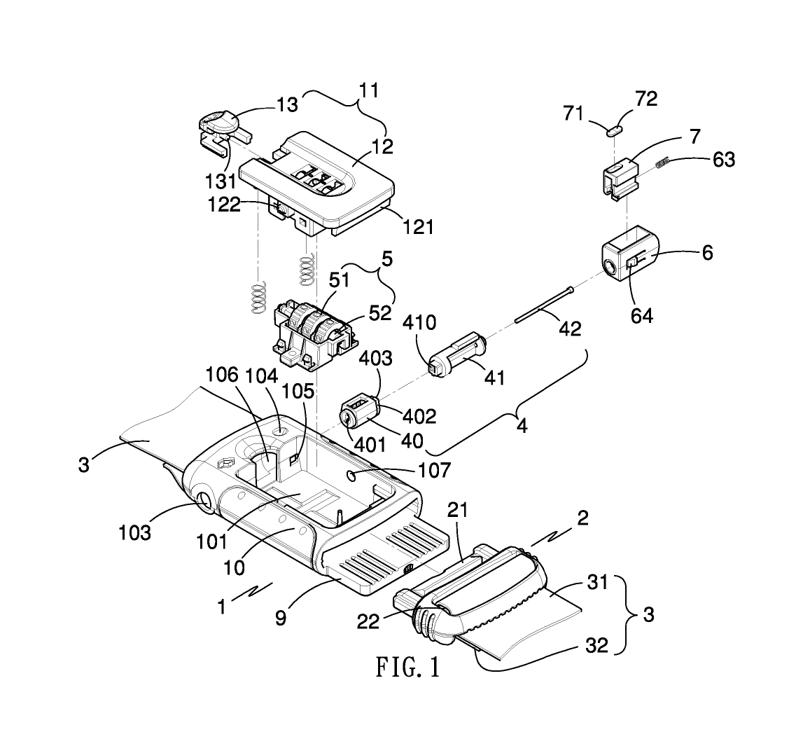

With reference to FIGS. 1 to 9, description will be given of a strap lock according to a first embodiment of this invention. The strap lock includes a first snapping member 1, a second snapping member 2, a strap 3, a key locking mechanism 4, a combination locking mechanism 5, a positioning mechanism 6 and an indicator 7.

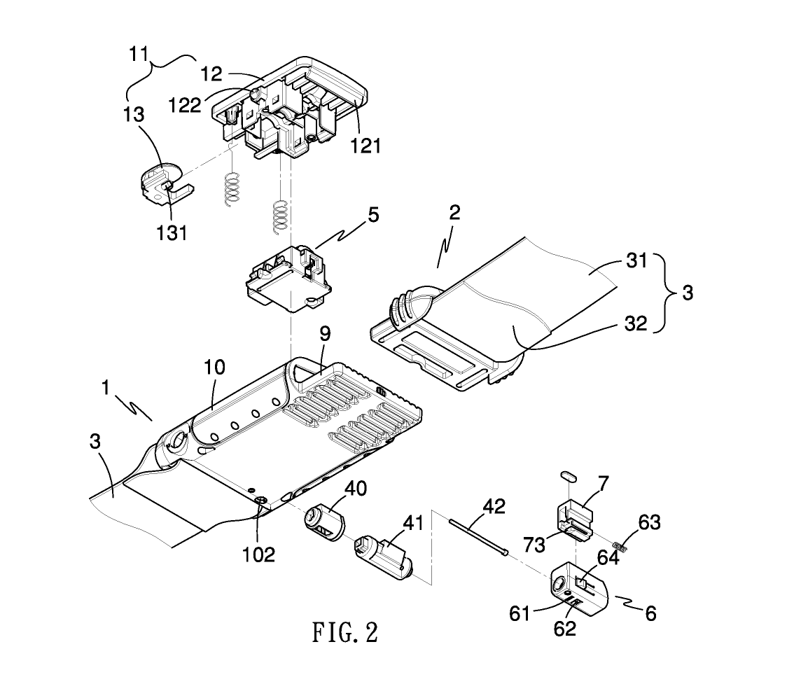

According to FIGS. 1 and 2, the first snapping member 1 is connected with one end of the strap 3 and includes a body 10, a controlling member 11 and a retaining portion 9. The body 10 defines a main room 101, an opening 102, a minor room 103 and a window 104. The main room 101 is defined in the center of the body 10 for receiving the controlling member 11. The opening 102 is defined in a bottom of the body 10, as depicted in FIG. 2, for restoring the indicator 7 to its original position, as will be explained hereinafter. The minor room 103 is defined in an end of the body 10 for receiving the key locking mechanism 4 and the positioning mechanism 6. The window 104 is disposed in the body 10 and corresponding to the indicator 7 which is disposed in the positioning mechanism 6. The window 104 is provided for showing statuses of the indicator 7, as will be set forth hereinafter. Furthermore, the body 10 defines a hole 105 and a space 106 in a partition between the main room 101 and the minor room 103. Both of the hole 105 and the space 106 are communicated with the main room 101 and the minor room 103. The hole 105 is provided for the positioning mechanism 6 to be secured in the minor room 103 of the body 10. The space 106 is provided for a block 41 of the key locking mechanism 4 to move, as will be discussed hereinafter.

The second snapping member 2 is connected to the other end of the strap 3 and is detachably connected to the first snapping member 1. Specifically, the second snapping member 2 comprises a crossbar 22 therein. The other end of the strap 3 includes a movable section 31 and a driven section 32. The movable section 31, close to a distal end of the other end of the strap 3, passes through the second snapping member 2, encompasses the crossbar 22 and comes out from the second snapping member 2. The driven section 32, adjacent to the movable section 31, is a part of the other end of the strap 3 that is not fed into the second snapping member 2. The movable section 31 and the driven section 32 overlap. In a normal condition, when the first and the second snapping members 1, 2 are buckled, the movable section 31 of the other end of the strap 3 is limited to be pulled in a direction away from the second snapping member 2 so as to adjust a loop size defined by the strap 3 for binding up a luggage tightly. Unlike the movable section 31, the driven section 32 is not allowed to be pulled in the direction, parallelly with the movable section 31, away from the second snapping member 2 because the adjacent movable section 31 is suffered from the turning of the crossbar 22 and other restrictions. Thus, there should be no way for the movable section 31 to move in a reverse direction by pulling the driven section 32 in the parallel direction to loosen the strap 3. However, if there is nothing underlying the second snapping member 2, except the luggage, the second snapping member 2 can be easily rotated or lifted up about the first snapping member 1, which enlarges the included angle between the movable section 31 and the driven section 32. In such a manner, the turning effect is lowered, and the driven section 32 becomes easily pulled in the direction to reverse the movable section 31 into the snapping member 2 so as to loosen the strap 3. And the luggage is in danger.

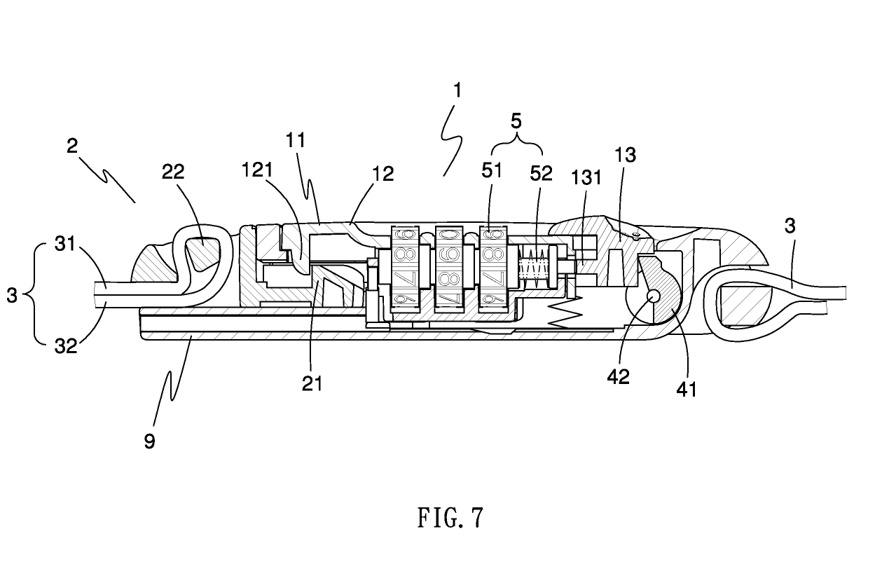

As noted above, according to FIGS. 2 and 7, the retaining portion 9 extends from an edge of the first snapping member 1 toward the second snapping member 2 to hold the movable section 31 and the driven section 32 parallel to each other. Specifically, when the first and the second snapping members 1, 2 are connected, the retaining portion 9 is right underlying the second snapping member 2. In such a manner, the other end of the strap 3, namely the movable section 31 and the driven section 32, is sandwiched between the retaining portion 9 and the second snapping member 2 so that the movable section 31 and the driven section 32 hold parallel to each other. Even if the second snapping member 2 is tried to be lifted up, however, the driven section 32 is not allowed to be pulled as a result of the driven section 32 paralleling to the movable section 32. Thus, the trying to lift up the second snapping member 2 will doom to failure, and the strap 3 is still binding the luggage tightly. The security of the luggage is greatly improved.

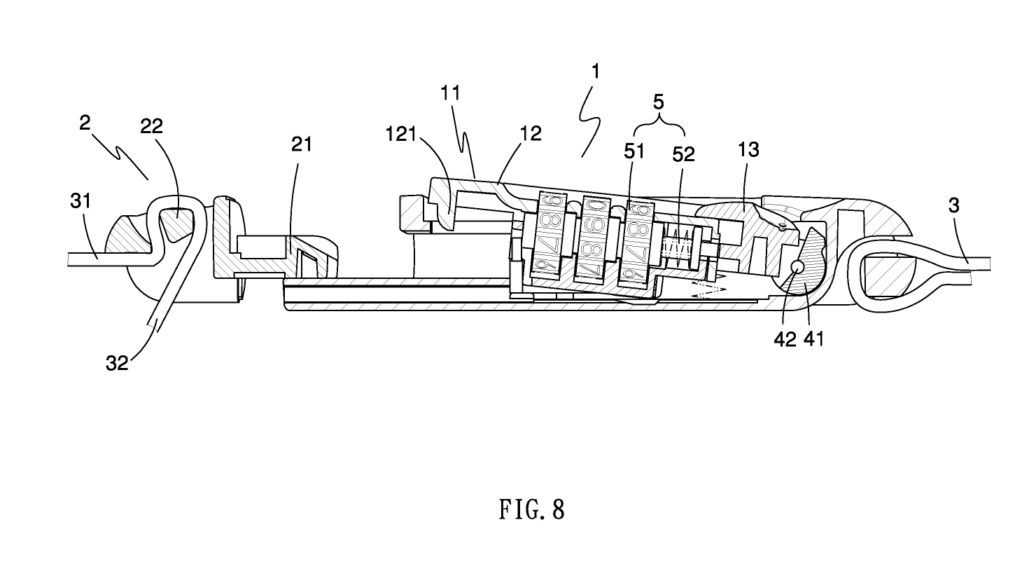

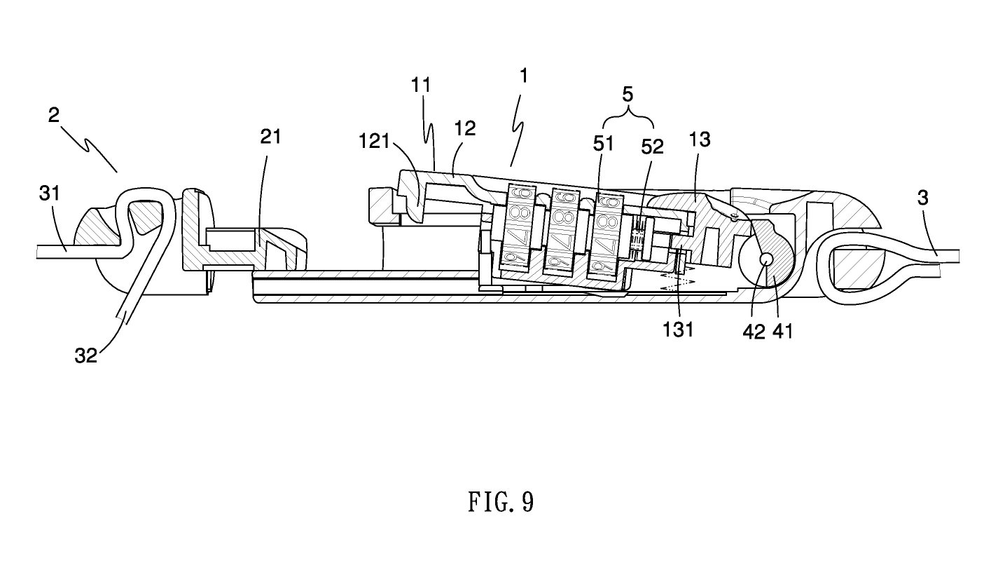

Referring back to FIG. 1, the controlling member 11 of the first snapping member 1 is disposed in the main room 101 and includes a cover 12 and a push button 13. The cover 12 has two coaxial shafts 122 each formed in the middle of one of opposite two edges thereof. The two shafts 122 are correspondingly positioned in two opposite holes 107 which are defined in walls of the main room 101. In such a manner, the controlling member 11 is swingable about the shafts 122 to a first position where the controlling member 11 grips the second snapping member 2, and a second position where the controlling member 11 releases the second snapping member 2 within the main room 101. As can be seen in FIG. 7, when the second snapping member 2 is buckled into the first snapping member 1, the controlling member 11 is in the first position with its engaging portion 121 formed on the cover 12 gripping a tongue 21 of the second snapping member 2 such that the second snapping member 2 is not allowed to be detached from the first snapping member 1. Contrarily, as shown in FIGS. 8 and 9, when the controlling member 11 swings to the second position to lift the engaging portion 121 up, the tongue 21 is released from the engaging portion 121, and thereby the second snapping member 2 is allowed to be detached from the first snapping member 1. In addition, the push button 13 is movably disposed on the cover 12.

The key locking mechanism 4 can lock the controlling member 11 in the first position or unlock the controlling member 11 to allow the controlling member 11 moving back to the second position via a key (not shown). Concretely speaking, referring to FIGS. 1 and 2, the key locking mechanism 4 comprises a lock core 40, the block 41 and a movable bar 42. The lock core 40 has a core shaft 402. The core shaft 402 defines a key hole 401 in one end and defines a first through hole 403 along an axis thereof. The first through hole 403 is in communication with the key hole 401. The key can be inserted into the key hole 401 so as to drive the core shaft 402 to rotate. The block 41 engages with the other end of the core shaft 402 and defines a second through hole 410 aligned with the first through hole 403. The bar 42 is disposed in the second through hole 410 with one end reaching to the first through hole 403 and the other end reaching to the positioning mechanism 6 and abutting against the indicator 7. As shown in FIG. 7, the block 41 has a top against the push button 13 of the controlling member 11 so that the push button 13 is not allowed to be pushed down but keeps still, which confines the controlling member 11 in the first position. Contrarily, as illustrated in FIG. 8, the core shaft 402 can be driven by the key so as to drive the block 41 to rotate apart from the push button 13. In this state, the push button 13 is allowed to be pushed, which allows the controlling member 11 to swing from the first position to the second position.

Referring to FIG. 2, the positioning mechanism 6 is disposed in the minor room 103 of the first snapping member 1. The position mechanism 6 includes a resilient member 63, a first resilient hook 64 and a bottom defining a first aperture 61 and a second aperture 62 therein. The first resilient hook 64 is caught in the hole 105 of the body 10 correspondingly so that the positioning mechanism 6 is positioned in the minor room 103 of the body 10. In addition, the bottom of the positioning mechanism 6 is further riveted with the body 1 for more security.

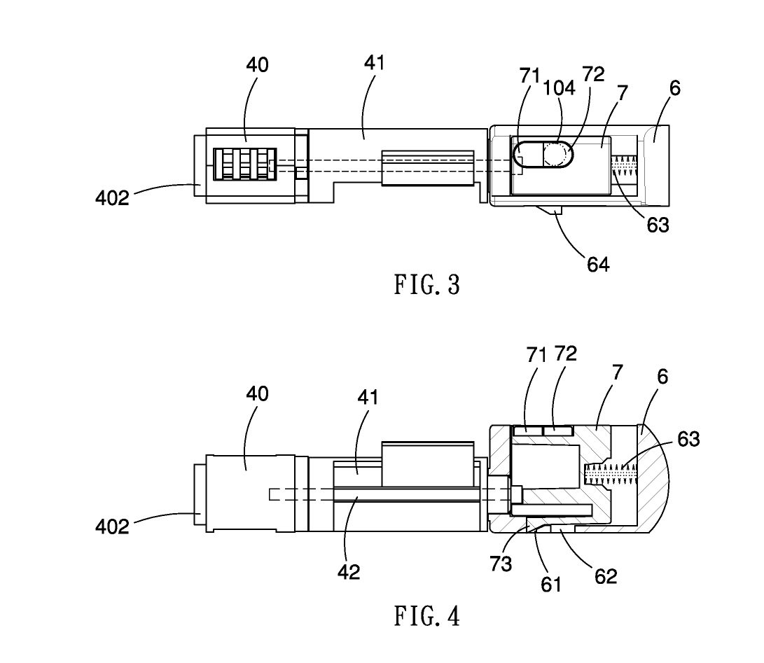

The indicator 7 is disposed in the positioning mechanism 6 and has a second resilient hook 73 therebottom, as shown in FIG. 2, and two different identification areas 71, 72 theretop, as shown in FIG. 1. One is the red identification area 71, and the other is the green identification area 72. The indicator 7 is movable to a first displaying position where the red one 71 is displayed in the window 104 and a second displaying position where the green one 72, in place of the red one 71, is displayed in the window 104. As shown FIGS. 3 and 4, when the indicator 7 is in the first displaying position, the second resilient hook 73 of the indicator 7 is caught in the first aperture 61 of the positioning mechanism 6 and the green one 72 is displayed in the window 104. In this state, the resilient member 63 of the positioning mechanism 6 is not compressed and abuts against a rear end of the indicator 7.

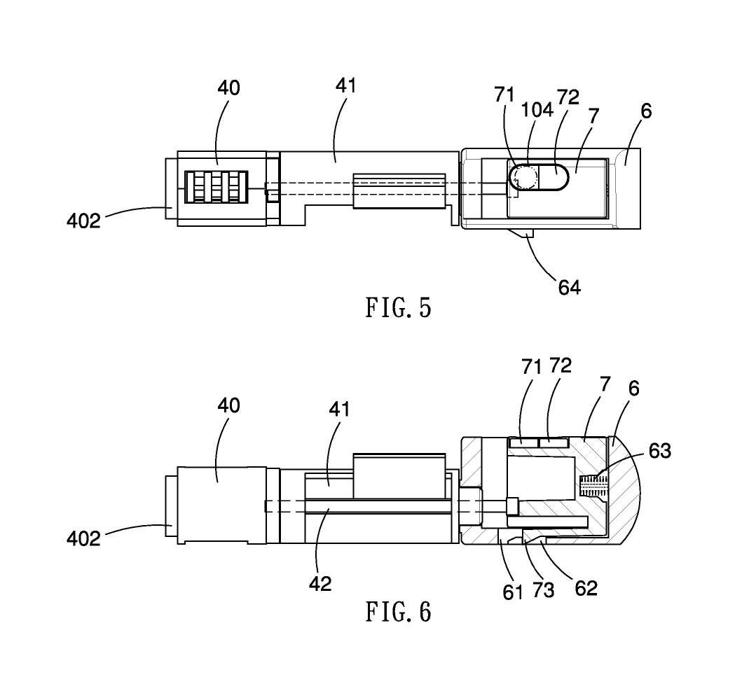

When the key or an object is inserted into the key hole 401 of the core shaft 402, the key or the object pushes the bar 42 which continues to move the indicator 7 from the first displaying position to the second displaying position, as shown in FIGS. 5 and 6, where the second resilient hook 73 is caught in the second aperture 62 of the positioning mechanism 6, and the resilient member 63 is compressed. In this state, the window 104 displays the red identification area 71 instead of the green one 72. Thus, a user can identify whether the strap lock has been inserted by the key or the object via color shift in the window 104.

Referring to FIG. 2, the second aperture 62 of the positioning mechanism 6 is in communication with the opening 102 of the first snapping member 102. When the indicator 7 is in the second displaying position, the opening 102 can be inserted by an insert (not shown) to move the second resilient hook 73 of the indicator 7 away from the second aperture 62 such that the indicator 7 can further be pushed by the compressed resilient member 63 back to the first displaying position, as depicted in FIGS. 3 and 4. Accordingly, it is very convenient for the user to restore the indicator 7 back to the first displaying position through the opening 102.

The combination locking mechanism 5 is disposed on the controlling member 11 of the first snapping member 1. The combination locking mechanism 5 can lock the controlling member 11 in the first position or unlock the controlling member 11 via a code to allow the controlling member 11 to move to the second position. Concretely speaking, as shown in FIGS. 1 and 7, the combination locking mechanism 5 comprises a numeral wheel assembly 51 and a movable shaft 52. The movable shaft 52 is disposed in the 22 numeral wheel assembly 51 with one end abutting against a protrusion 131 of the push button 13 of the controlling member 11. Thus, movement of the push button 13 depends on whether the movable shaft 52 is allowed to move or not. When the numeral wheel assembly 51 of the combination locking mechanism 5 is not dialed to a code, the movable shaft 52 is not allowed to move so that the push button 13 is not allowed to be pushed forward to be departed from the block 41, and thereby the controlling member 11 is confined in the first position. Contrarily, as shown in FIG. 9, when the combination locking mechanism 5 is entered the code, the movable shaft 52 is allowed to move so that the push button 13 is allowed to be pushed in a direction toward the movable shaft 52 to be released from the block 41, and thereby the controlling member 11 is allowed to swing to the second position.

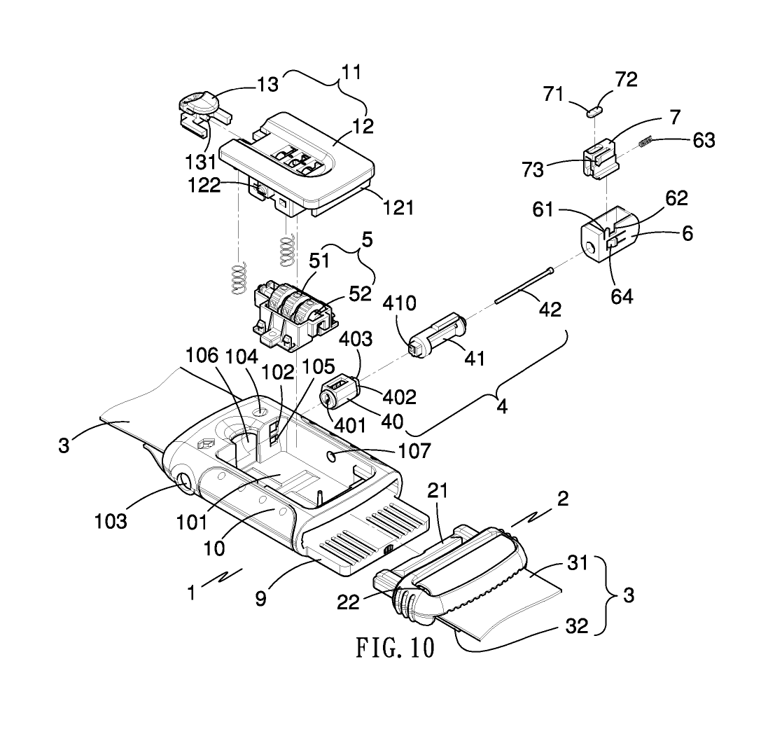

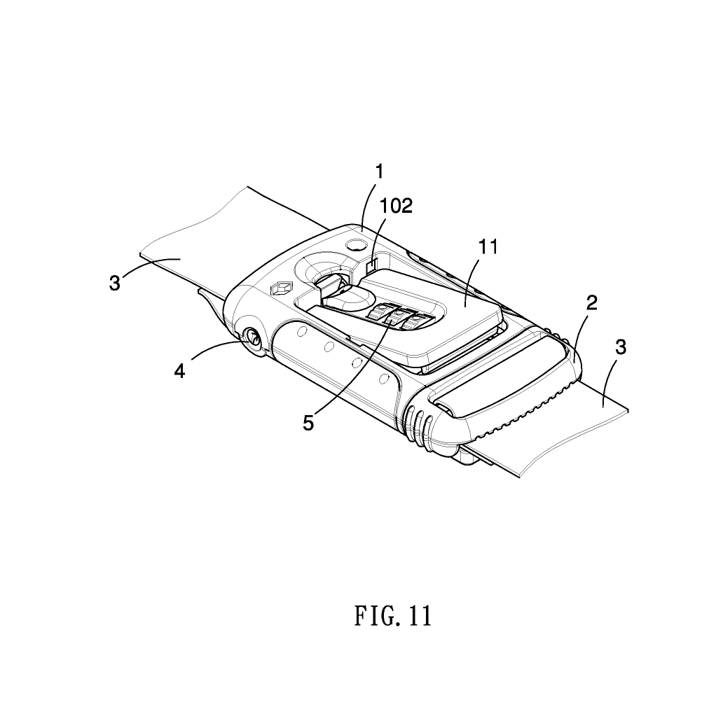

Referring now to FIGS. 10 and 11, a second embodiment of a strap lock is essentially the same as the first embodiment shown in FIGS. 1 through 9 except that the indicator 7 and other relative parts are modified for restoring.

In the second embodiment, the opening 102 of the first snapping member 1 is defined in the partition between the main room 101 and the minor room 103 of the body 1 and located under the hole 105, not as the opening 102 of the first embodiment, which is defined in the bottom of the body 10. In addition, for the position of the opening 102 in FIG. 10, the second resilient hook 73, the first aperture 61 and the second aperture 62 are correspondingly rearranged to sides of the indicator 7 and the positioning mechanism 6, not as bottoms of the indicator 7 and the positioning mechanism 6 disclosed in the first embodiment. In particular, when the controlling member 11 is in the first position, the opening 102 is hidden by the controlling member 11. Contrarily, as depicted in FIG. 11, when the controlling member 11 is in the second position, the opening 102 is exposed. As mentioned above, although the controlling member 11 can be released by either one of the key locking mechanism 4 and the combination locking mechanism 5 to be moved to the second position so as to expose the opening 102. However, if the key locking mechanism 4 is used to release the controlling member 11, since the key keeps in a status abutting against the bar 42 which blocks one end of the indicator 7, even if an insert is tried to be inserted into the opening 102 to release the indicator 7, the indicator 7 is still stuck between the compressed resilient member 63 and the bar 42. The indicator 7 can not be pushed back to its original position. Contrarily, if the combination locking mechanism 5 is used to release the controlling member 11, the indicator 7 won't be blocked so that the opening 102 can be inserted by the insert to enable the resilient member 63 to push the indicator 7 from the second displaying position to the first displaying position. Besides, the opening 102 can be inserted by the insert to restore the indicator 7 back to its original position only when the opening 102 is exposed, that is, when the combination locking mechanism 5 is entered the code and the controlling member 11 is in the second position. In other words, it is possible for the indicator 7 moving from the second displaying position to the first displaying position only when the combination locking mechanism 5 is entered the code.

Numerous characteristics and advantages of the invention have been set forth in the foregoing description. The disclosure, however, is illustrative only, and changes may be made in detail within the principle of the invention, to the full extent indicated by the broad general meaning of the terms in which the appended claims are expressed.

1. A strap lock comprising:
a strap;
a first snapping member connected with one end of the strap;
a second snapping member being detachably connected to the first snapping member and comprising a crossbar for being looped by the other end of the strap such that a distal end of the other end of the strap is limited to be pulled in a direction away from the second snapping member so as to adjust a loop size defined by the strap;
a key locking mechanism disposed on the first snapping member and including a core shaft defining a key hole for being inserted by a specific key such that the core shaft can be driven by the key to release the second snapping member from the first snapping member; and
an indicator movably disposed on the first snapping member wherein when the key is inserted into the key hole of the core shaft, the indicator moves from a first displaying position to a second displaying position.

2. The strap lock of claim 1 wherein the first snapping member defines an opening capable of receiving an insert to enable the indicator to move from the second displaying position to the first displaying position.

3. The strap lock of claim 2 further comprising a positioning mechanism disposed on the first snapping member; the positioning mechanism having a first aperture, a second aperture and a resilient member; the resilient member abutting against an end of the indicator; the indicator including a resilient hook caught in the first aperture when the indicator is in the first displaying position and caught in the second aperture when the indicator is in the second displaying position; the second aperture being in communication with the opening; and wherein when inserted into the opening, the insert pushes the resilient hook of the indicator to release the resilient hook from the second aperture such that the indicator is pushed back to the first displaying position by the resilient member of the positioning mechanism.

4. The strap lock of claim 1 wherein the key locking mechanism further includes a movable bar passing through the core shaft, the bar having one end communicating with the key hole, and the other end abutting against the indicator so that when the key is inserted into the key hole, the bar is pushed by the key to move the indicator to the second displaying position.

5. The strap lock of claim 1 further comprising a retaining portion extending from an edge of the first snapping member toward the second snapping member such that when the first and the second snapping member are connected, the other end of the strap is sandwiched between the retaining portion and the second snapping member.

6. The strap lock of claim 1 wherein the first snapping member includes a body and a controlling member; the controlling member being disposed on the body and movable to a first position where the controlling member grips the second snapping member, and a second position where the controlling member releases the second snapping member; and the key locking mechanism can lock the controlling member in the first position or unlock the controlling member to allow the controlling member moving back to the second position.

7. The strap lock of claim 6 wherein the key locking mechanism further includes a movable bar and a block; the bar passing through the core shaft and the block and having one end communicating with the key hole, and the other end abutting against the indicator such that when the key is inserted into the key hole, the bar is pushed by the key to move the indicator to the second displaying position; and the core shaft can drive the block to confine the controlling member in the first position or to depart from the controlling member to allow the controlling member to move to the second position.

8. The strap lock of claim 6 further comprising a combination locking mechanism disposed on the controlling member; the combination locking mechanism being capable of locking the controlling member in the first position and unlocking the controlling member via a code to allow the controlling member to move to the second position.

9. The strap lock of claim 8 wherein the controlling member includes a push button; the key locking mechanism includes a block; the block blocks the push button of the controlling member and retrains the controlling member from moving to the second position; when driven by the key, the core shaft drives the block to depart from the push button of the controlling member to allow the controlling member moving to the second position; and when the combination locking mechanism is entered the code, the push button can be pushed and released from the block so as to allow the controlling member moving to the second position.

10. The strap lock of claim 9 wherein the key locking mechanism further includes a movable bar passing through the core shaft and the block and having one end communicating with the key hole, and the other end abutting against the indicator such that when the key is inserted into the key hole, the bar is pushed by the key to move the indicator to the second displaying position.

11. The strap lock of claim 1 further comprising a combination locking mechanism disposed on the first snapping member; wherein the combination locking mechanism can release the second snapping member from the first snapping member by entering a code; and the indicator is allowed moving from the second displaying position to the first displaying position only when the combination locking mechanism is entered the code.

12. The strap lock of claim 11 wherein the first snapping member defines an opening; the opening allows an insert to be inserted therethrough to enable the indicator to move from the second displaying position to the first displaying position only when the combination locking mechanism is entered the code.

13. The strap lock of claim 11 wherein the first snapping member includes a body and a controlling member; the controlling member is disposed on the body and movable to a first position where the controlling member grips the second snapping member, and a second position where the controlling member releases the second snapping member; the key locking mechanism can lock the controlling member in the first position or unlock the controlling member by the key to allow the controlling member moving back to the second position; and the combination locking mechanism can lock the controlling member in the first position or unlocking the controlling member by the code to allow the controlling member moving back to the second position.

14. The strap lock of claim 13 wherein the first snapping member defines an opening which is hidden when the controlling member is in the first position and is exposed when the controlling member is in the second position; and when exposed, the opening can be inserted by an insert to enable the indicator moving from the second displaying position to the first displaying position.

15. The strap lock of claim 14 wherein the controlling member includes a push button; the key locking mechanism includes a block; the block blocks the push button of the controlling member and retrains the controlling member from moving to the second position; when driven by the key, the core shaft drives the block to depart from the push button of the controlling member to allow the controlling member moving to the second position; and when the combination locking mechanism is entered the code, the push button can be pushed and released from the block so as to allow the controlling member moving to the second position.

16. The strap lock of claim 15 wherein the key locking mechanism further includes a movable bar passing through the core shaft and the block and having one end communicating with the key hole, and the other end abutting against the indicator such that when the key is inserted into the key hole, the bar is pushed by the key to move the indicator to the second displaying position.

17. A strap lock comprising:
a strap;
a first snapping member connected with one end of the strap;
a second snapping member connected with the other end of the strap and detachably connected to the first snapping member;
a key locking mechanism disposed on the first snapping member and including a core shaft defining a key hole for being inserted by a specific key such that the core shaft can be driven by the key to release the second snapping member from the first snapping member; and
an indicator movably disposed on the first snapping member, wherein when the key is inserted into the key hole of the core shaft, the indicator moves from a first displaying position to a second displaying position; and
a combination locking mechanism disposed on the first snapping member and being able to release the second snapping member from the first snapping member by entering a code.

18. The strap lock of claim 17 wherein the indicator is allowed to move from the second displaying position to the first displaying position only when the combination locking mechanism is entered the code.

19. The strap lock of claim 17 wherein the first snapping member defines an opening capable of receiving an insert to enable the indicator to move from the second displaying position to the first displaying position.

20. The strap lock of claim 17 wherein the key locking mechanism further includes a movable bar passing through the core shaft, the bar having one end communicating with the key hole, and the other end abutting against the indicator so that when the key is inserted into the key hole, the bar is pushed by the key to move the indicator to the second displaying position.
